(19) United States
(12) Patent Application Publication
(10) Pub. No.: US 2010/0197867 A1
(43) Pub. Date: Aug. 5, 2010

(54) BINDING AGENTS HAVING HIGH OH NUMBER AND CLEAR PAINT COMPOSITION COMPRISING SAID AGENTS AND HAVING GOOD OPTICAL CHARACTERISTICS AND GOOD SCRATCH AND CHEMICAL RESISTANCE

(75) Inventors: Rui Niimi, Yokohama (JP); Andreas Poppe, Shanghai (CN); Gunter Klein, Munster (DE); Bjorn Feldmann, Munster (DE); Ulrike Clausen-Meiring, Senden (DE)

Correspondence Address: Mary E. Golota;Cantor Colburn LLP, 201 W. Big Beaver Road, Suite 1101, Troy, MI, 48084, US

(73) Assignees: BASF COATINGS JAPAN LTD., Yokohama (JP); BASF COATINGS AG, Munster (DE)

(21) Appl. No.: 12/663,357

(22) PCT Filed: Jun. 5, 2008
(86) PCT No.: PCT/EP08/04494

§ 371 Date: Apr. 6, 2010

(30) Foreign Application Priority Data
Jun. 6, 2007 (DE) 102007026724.1

(51) Int. Cl. C08L 33/08; C08G 63/02; C08F 220/26; C08L 67/00

(52) U.S. Cl. 525/375; 528/271; 526/320; 525/450; 525/55

(57) ABSTRACT

Disclosed are hydroxyl-functional binders having an OH number greater than or equal to 180 mg KOH/g as determined in accordance with DIN 53240 and a solubility parameter SP=10, and to clearcoat compositions comprising said binders. Also disclosed are processes for preparing the disclosed hydroxyl-functional binders, methods of making coated automotive substrates by applying the disclosed clearcoat compositions to automotive substrates, and to coated substrates made therefrom.

The present invention relates to hydroxy-functional binders having a high hydroxyl number and to clearcoat compositions comprising the binder. The invention further relates to processes for preparing the hydroxy-functional binders, to their use for producing clearcoating compositions for automotive OEM finishing, and to substrates coated with them.

In coating systems, especially in automotive finishing, clearcoats act as the final layer, for protecting the underlying layers against mechanical damage and weathering effects. They ought additionally to endow the automotive finish with gloss, depth, and brilliant effects.

Clearcoat compositions are typically solvent-based. To minimize the emission of organic solvents during drying, on environmental grounds, and to reduce costs, the clearcoat compositions typically have a high solids content.

Typical 1-component and 2-component clearcoat compositions from automotive OEM finishing comprise acrylate—or polyester polyol binders which are cured using diisocyanates or polyisocyanates. For the purpose of obtaining lightfast and weather-resistant, universally useful coating materials, curing agents used are, in particular, hexamethylene diisocyanate (HDI) and isophorone diisocyanate (IPDI) curing agents. Preference is given to using HDI, which enables coatings having good crosslinking and resistance to be obtained. Polymeric isocyanurate curing agents are particularly widespread on account of their comparatively low sensitization potential and their ready commercial availability. A particularly preferred curing agent used is an HDI isocyanurate, because coating compositions comprising this curing agent have a low viscosity and hence have good processing properties and exhibit good leveling.

Clearcoat materials from the automotive sector additionally, advantageously, possess further positive properties, such as scratch resistance and chemical resistance, for example. It is known in the art that good scratch resistance and chemical resistance are achievable through the use of a polyol component having a high OH number.

Polyol components used in prior-art automotive OEM clearcoat materials include, in particular, polyacrylate polyols (BASF Handbuch Lackiertechnik, A. Goldschmidt, H.-J. Streitberger, Vincentz Verlag, Hanover, 2002, p. 732). Clearcoat compositions based on polyacrylate polyols are notable for good chemical resistance and also for good hardness, which is explained by a combination of high OH numbers on the part of the polyacrylate polyols with a low molecular weight on the part of the binder. However, particularly with high polyacrylate polyol OH numbers and/or high clearcoat composition solids contents, clearcoat materials based on polyacrylate polyols do not possess satisfactory optical properties (appearance).

High OH numbers of the kind possessed by the polyacrylate polyols cannot be realized with conventional polyester polyols at low molecular weights (Polyester and Alkydharze, U. Poth, Vincentz Verlag, Hanover, 2005, p. 44 ff.). In their cured state, clearcoat compositions comprising conventional polyester polyols possess good optical properties but comparatively poor scratch and chemical resistance as compared with the prior-art polyacrylate polyols, especially in 2-component clearcoat formulations. A further drawback is that, with conventional polyester polyols, the higher the OH number set in the polyester, the less favorable, i.e., the broader, the molecular weight distribution becomes. This broad molecular weight distribution may give rise to incompatibilities in corresponding clearcoat compositions. Moreover, even small fractions of high molecular weight resin constituents frequently lead to extremely high viscosities, which considerably restrict further processing. Moreover, at the polyester synthesis stage, it is necessary to take account of the low acid number essential for the resulting binders. This necessity is imposed by the catalytic activity of the acid group and by the associated repercussions for storage stability and processing properties of the materials. Moreover, the preparation of these conventional polyester polyols with high OH numbers may be accompanied by gelling of the polyesters as an unwanted secondary reaction.

Even mixtures of conventional polyester polyols and polyacrylate polyols do not lead to clearcoat compositions featuring good optical properties and satisfactory scratch and chemical resistance, especially in 2-component clearcoat formulations.

It is an object of the present invention, therefore, to provide binders for high-solids clearcoat compositions that produce coatings featuring high scratch resistance, high chemical resistance, and good optical properties.

This object is achieved by means of a hydroxy-functional binder having a high hydroxyl number, said binder having a hydroxyl number=180 mg KOH/g, determined in accordance with DIN 53240, and a solubility parameter SP=10. The solubility parameter SP is determined in accordance with the method described in Journal of Applied Polymer Science, Vol. 12, 1968, pp. 2359-2370. For this method, 0.5 g of binder is diluted with 5 g of acetone. Then n-hexane or DI water (DIW=DeIonizedWater) is titrated in until a turbidity is developed.

The solubility parameter SP can be calculated therefrom as follows:

$$SP = \frac{\sqrt{{V}_{ml}} \cdot {δ}_{ml} + \sqrt{{V}_{mh}} \cdot {δ}_{mh}}{\sqrt{{V}_{ml}} + \sqrt{{V}_{mh}}} ,$$

where

Vₘₗ=(V_{acetone}·Vₙ₋ₕₑₓₐₙₑ)/(φ_{acetone}·Vₙ₋ₕₑₓₐₙₑ+φₙ₋ₕₑₓₐₙₑ·V_{acetone}),

Vₘₕ=(V_{acetone}·V_{DIW})/(φ_{acetone}·V_{DIW}+0_{DIW}·V_{acetone}),

δₘₗ=φ_{acetone}·δ_{acetone}=φₙ₋ₕₑₓₐₙₑ·δₙ₋ₕₑₓₐₙₑ,

δₘₕ=φ_{acetone}·δ_{acetone}=φ_{DIW}·δ_{DIW},

where
V_{acetone}, Vₙ₋ₕₑₓₐₙₑ, V_{DIW}=molar volume of the respective solvent,
φ_{acetone}, φₙ₋ₕₑₓₐₙₑ, φ_{DIW}=volume fraction of the respective solvent, and
δ_{acetone}, δₙ₋ₕₑₓₐₙₑ, δ_{DIW}=solubility parameter SP of the respective solvent (δ_{acetone}=9.75 (cal/cm³)^{1/2}, δₙ₋ₕₑₓₐₙₑ=7.24 (cal/cm³)^{1/2}, δ_{DIW}=23.43 (cal/cm³)^{1/2}).

The solubility parameter SP can be set through the choice of monomers having an appropriate polarity when preparing the binders and/or by the subsequent modification of conventional binders with substances possessing appropriate polarity. It is essential in this context that the monomers used and/or substances serving for modification have a sufficiently low polarity. Thus, for example, polar monomers such as the OH-carrying compounds 4-hydroxybutyl acrylate and hydroxyethyl methacrylate, for example, are disadvantageous for use in acrylates, for example, since they lead to high SP values. Not quite so strongly pronounced is the effect of aromatic compounds, such as styrene.

For the subsequent modification of the binders as well it is essential to select appropriate substances having a low polarity. Thus, for example, conventional OH-functional binders, especially polyesters, can be esterified with monocarboxylic acids, especially noncyclic aliphatic monocarboxylic acids, in order to obtain low SP values.

It is, however, essential in this context that the nonpolar monomers and/or substances for subsequent modification are not too long-chain, since this leads to poor results in the scratch resistance, chemical resistance, and hardness tests.

Surprisingly the binders of the invention not only solve the problems posed above but in addition can be used to produce clearcoat compositions having particularly high solids contents.

WO 97/22420 does disclose a multicoat coating system with a clearcoat comprising a copolymer of 20-50% by weight of a vinyl monomer with cyclic structure and 80-50% by weight of other vinylic monomers such as (meth)acrylates, for example, said copolymer having a T_{g} of 0-60° C., a solubility parameter as determined by the Fedors method (Polymer Engineering and Science 14 (2), 1974) of 9-11, and a weight-average molecular weight of 4000-30 000 g/mol. The cured coating film described therein is not susceptible to water spotting by acid rain, and possesses good optical properties. The coating films described in WO 97/22420, however, are not satisfactory in terms of their scratch resistance.

The binders disclosed therein have low OH numbers (cf. the examples); if an attempt is made to raise these OH numbers, however, high SP values are the automatic result.

As compared with this prior art, the focus of the present invention is on using binders having a high OH number and a low SP value at the same time.

Particularly good optical properties result if the binder of the invention has an SP of 8.8-10.0, preferably 9.2-10.0.

Particularly good chemical resistance and scratch resistance result if the binder has an OH number, determined in accordance with DIN 53240, of =200 mg KOH/g, preferably 200-240 mg KOH/g.

High compatibility with other coating composition ingredients, and good optical properties, result if the binder of the invention has a number-average molecular weight of =4000 g/mol, preferably 1500-4000 g/mol, more preferably 2000-3500 g/mol, determined via GPC with a polystyrene standard in THF with 0.1% by weight of acetic acid.

Preferably the binder is a polyester polyol, a polyacrylate polyol, a polyurethane polyol, a polyether polyol, a polycarbonate polyol or any desired mixtures of said polyol types. These binders represent preferred polyols for polyurethane curing, since they are easy to prepare and possess the hydroxyl groups necessary for polyurethane curing. With particular preference the binder is a polyester polyol, a polyurethane polyol, a polyether polyol, a polycarbonate polyol or any desired mixture of said polyols. With very particular preference the binder is a polyester polyol. Polyester polyols possess high compatibility with typical isocyanate curing agents, and also have the effect of a better filling capacity and better masking of roughnesses in coating compositions.

With particular preference at least one hydroxyl function of the polyester is esterified with at least one noncyclic aliphatic monocarboxylic acid. The esterification described above, with at least one noncyclic aliphatic monocarboxylic acid, is also referred to, synonymously, as acid modification. With very particular preference at least one hydroxyl function of the polyester is esterified with at least one acid selected from the group of isomeric C₈-C₉ monocarboxylic acids. In particular it is possible in this way to achieve satisfactory compatibility and therefore satisfactory gloss of the cured clearcoats. With very particular preference the at least one hydroxyl function of the polyester has been esterified with octanoic acid or isononanoic acid, more preferably still with isononanoic acid.

To achieve particularly high solids contents in clearcoat materials together with good leveling it is preferred to use binders having a polydispersity M_{w}/Mₙ<4. Particularly good properties result in this context if the binder has an even smaller polydispersity, i.e., <2.5, in particular =2.0.

With very particular preference the binder is a hyperbranched, dendritic compound. Hyperbranched, dendritic compounds, i.e., hyperbranched, dendritic macromolecules and dendrimers, can be described, generally speaking, as three-dimensional, highly branched molecules having a treelike structure. Dendrimers are highly symmetrical, whereas similar macromolecules referred to as hyperbranched and/or dendritic may to a certain extent be asymmetrical and nevertheless retain the highly branched treelike structure. The use of such compounds in clearcoat compositions permits particularly high solids contents in tandem with good leveling properties.

The hyperbranched, dendritic compound is preferably monodisperse (M_{w}/Mₙ=1) or substantially monodisperse (M_{w}/Mₙ^{˜}1).

With particular preference the binder is a monodisperse or substantially monodisperse polyester partially esterified with a noncyclic aliphatic monocarboxylic acid, preferably an isomeric C₈-C₉ monocarboxylic acid, the polyester being preparable easily, reliably, and reproducibly, and its properties and end structures being easily and conveniently adaptable.

Polyesters of this kind can be prepared by partial esterification of a hydroxy-functional polyester which in turn is preparable via a process for synthesizing a dendritic polymeric polyalcohol (polyester polyol) having reactive and, optionally, protected hydroxyl end groups in accordance with EP 991 690 B1,
the polymeric polyalcohol possessing n dendritic branches which spring from a monomeric or polymeric initiator molecule having n reactive groups (A), each branch comprising g branching generations, each generation comprising at least one polymeric or monomeric branching chain extender having three functional groups, of which at least two are reactive hydroxyl groups (B) and one is a carboxyl group (C) which is reactive with the reactive group (A) and/or the hydroxyl groups (B), and comprising, if desired, at least one spacer generation which comprises at least one spacer chain extender having two functional groups, of which one is a protected hydroxyl group (B″) and one is a group (D) which is reactive with a hydroxyl group, n and g being integers and being at least 1,
(i) the two hydroxyl groups (B) of the monomeric or polymeric chain branching extender used being acetal-protected hydroxyl groups (B′), the acetal protection being obtained through a reaction between the two hydroxyl groups (B) and an acetal-forming carbonyl compound; and
(ii) a first branching generation being added to the initiator molecule by reaction between the reactive group (A) and the carboxyl group (C), in a molar ratio of the reactive groups (A) to the carboxyl groups (C) of at least 1, to give a polymeric polyalcohol having acetal-protected hydroxyl groups (B′) and n dendritic branches which comprise one generation, the acetal-protected hydroxyl groups (B′) being deprotected, if desired, by means of acetal cleavage, to give a polymeric polyalcohol having reactive hydroxyl groups (B); and
(iii) further branching generations being added in g−1 repeated steps by reaction between reactive hydroxyl groups (B), which are obtained by deprotection by means of acetal cleavage, and carboxyl groups (C), in a molar ratio of hydroxyl groups (B) to carboxyl groups (C) of least 1, to give a polymeric polyalcohol having acetal-protected hydroxyl groups (B′) and n dendritic branches, which comprise two or more generations, the acetal-protected hydroxyl groups (B′) being deprotected, if desired, by means of acetal cleavage, to give a polymeric polyalcohol having reactive hydroxyl groups (B), and
optionally (iv) step (ii) and/or each repetition of step (iii) individually is followed by
   (a) a partial protection, such as protection as acetal, ketal and/or ester, for example, of available reactive hydroxyl groups (B), to give a polymeric polyalcohol having at least one reactive hydroxyl group (B) for use in step (iii) or in a repeated step (ii), and/or by
   (b) the addition of the optional spacer chain extender, which after deprotection of the protected hydroxyl group (B″) gives a polymeric polyalcohol having reactive hydroxyl groups (B) for use in step (iii) or in a repeated step (iii) and n dendritic branches, which comprise one or more branching generations, and at least one spacer generation is at least one subgeneration.

For clearcoat compositions with the binders of the invention to possess good potlives they preferably have acid numbers, determined in accordance with DIN 53402, of =10, preferably =8.

The present invention further provides a clearcoat composition comprising at least one binder of the invention. The clearcoat composition preferably further comprises at least one curing agent.

Particularly good coatings having particularly high scratch resistance and chemical resistance and particularly good optical properties result when the difference in the SP values of the binder and of the curing agent, as determined by the method outlined above, is not more than 1.0, preferably 0.8, with particular preference 0.5.

Curing agents which can be used in the clearcoat compositions include, in particular, isocyanate curing agents and other crosslinkers, such as amino resin curing agents and trisalkoxycarbonylaminotriazines (TACT), for example, alone or in combination with one another. It is preferred to use aliphatic and/or cycloaliphatic isocyanates, alone or in combination with further crosslinking agents.

For the purpose of achieving lightfast and weather-resistant, universally useful coating materials, preference is given in particular to using hexamethylene diisocyanate (HDI) and isophorone diisocyanate (IPDI) curing agents in the clearcoat compositions. Preferably at least one HDI curing agent is used, with which coatings featuring good crosslinking and resistance are obtained.

Polymeric isocyanurate curing agents are used with preference in the clearcoat compositions of the invention, on account of their comparatively low sensitization potential and their ready commercial availability. A particularly preferred curing agent used is an HDI isocyanurate, since corresponding coating compositions which comprise this curing agent exhibit low viscosity and hence have good processing properties and exhibit good leveling.

The clearcoat compositions contain preferably 35% to 65% by weight of binder and 65% to 35% by weight of curing agent, based on the solids content of the clearcoat, the fractions adding up to 100%.

The clearcoat compositions of the invention are preferably 2-component clearcoat compositions. This prevents binder and curing agent possibly curing prior to application.

The present invention further provides a process for preparing a hydroxy-functional binder of the invention, which involves first of all
preparing a dendritic polyester polyol having reactive and optionally protected hydroxyl end groups, the polyester polyol possessing n dendritic branches which spring from a monomeric or polymeric initiator molecule having n reactive groups (A), each branch comprising g branching generations, each generation comprising at least one polymeric or monomeric branching chain extender having three functional groups, of which at least two are reactive hydroxyl groups (B) and one is a carboxyl group (C) which is reactive with the reactive group (A) and/or the hydroxyl groups (B), and comprising, if desired, at least one spacer generation which comprises at least one spacer chain extender having two functional groups, of which one is a protected hydroxyl group (B″) and one is a group (D) which is reactive with a hydroxyl group, n and g being integers and being at least 1,
(i) the two hydroxyl groups (B) of the monomeric or polymeric chain branching extender used being acetal-protected hydroxyl groups (B′), the acetal protection being obtained through a reaction between the two hydroxyl groups (B) and an acetal-forming carbonyl compound; and
(ii) a first branching generation being added to the initiator molecule by reaction between the reactive group (A) and the carboxyl group (C), in a molar ratio of the reactive groups (A) to the carboxyl groups (C) of at least 1, to give a polyester polyol having acetal-protected hydroxyl groups (B′) and n dendritic branches which comprise one generation, the acetal-protected hydroxyl groups (B′) being deprotected, if desired, by means of acetal cleavage, to give a polyester polyol having reactive hydroxyl groups (B); and
(iii) further branching generations being added in g−1 repeated steps by reaction between reactive hydroxyl groups (B), which are obtained by deprotection by means of acetal cleavage, and carboxyl groups (C), in a molar ratio of hydroxyl groups (B) to carboxyl groups (C) of least 1, to give a polyester polyol having acetal-protected hydroxyl groups (B′) and n dendritic branches, which comprise two or more generations, the acetal-protected hydroxyl groups (B′) being deprotected, if desired, by means of acetal cleavage, to give a polyester polyol having reactive hydroxyl groups (B), and
optionally (iv) step (ii) and/or each repetition of step (iii) individually is followed by
   (a) a partial protection, such as protection as acetal, ketal and/or ester, for example, of available reactive hydroxyl groups (B), to give a polyester polyol having at least one reactive hydroxyl group (B) for use in step (iii) or in a repeated step (ii), and/or by
   (b) the addition of the optional spacer chain extender, which after deprotection of the protected hydroxyl group (B″) gives a polyester polyol having reactive hydroxyl groups (B) for use in step (iii) or in a repeated step (iii) and n dendritic branches, which comprise one or more branching generations, and at least one spacer generation is at least one subgeneration;
followed by a partial esterification of the polyester polyol with a noncyclic aliphatic monocarboxylic acid, preferably an isomeric C₈-C₉ monocarboxylic acid.

The invention further provides a process for preparing a hydroxy-functional binder of the invention, which involves partially esterifying a hyperbranched, dendritic, hydroxy-functional polyester with at least one noncyclic aliphatic monocarboxylic acid, preferably at least one isomeric C₈-C₉ monocarboxylic acid.

The invention further provides for the use of at least one hydroxy-functional binder of the invention for producing clearcoating compositions for automotive OEM finishing, for the finishing of body-mounted components or commercial vehicles, and for refinishing. The clearcoat compositions are preferably suitable for use in the wet-on-wet method. In this method an optionally pretreated substrate optionally coated preliminarily with a cathodic electrocoat primer and a surfacer is coated in two steps first with the basecoat material and then with a clearcoat material. “Wet-on-wet” here means that both coating materials are applied soon after one another without baking of the basecoat material, before then being jointly baked and crosslinked. With particular preference the clearcoat material of the invention is used in a finishing process in which a substrate coated with a baked cathodic electrocoat is coated with a modified basecoat material, after intermediate flash-off a basecoat material is applied, after a further flash-off a clearcoat material is applied, and after an optional flash-off the coating components are jointly baked. In this method no conventional surfacer is used.

The invention further provides substrates coated with a clearcoat composition of the invention. Substrates of this kind are optionally pretreated substrates which optionally have been coated preliminarily with a cathodic electrocoat primer and a surfacer, and are composed of steel, galvanized steel or aluminum, of the kind employed in the manufacture of automobile bodies.

### EXAMPLES

### Inventive Example 1

### Preparation of the Polyester SP1

A reactor provided with a stirrer, reflux condenser, and water separator is charged with 1523 parts by weight of isononanoic acid, and 40 parts by weight of xylene are added. The mixture is carefully heated to 80° C., with stirring. Then 4439 parts by weight of a dendritic hydroxy-functional polyester (Boltorn H 30, available from Perstorp) are added slowly in order to avoid lumps forming. Following the addition, the reaction mixture is heated to 200° C. To monitor the course of the reaction, the volume of the condensate is recorded, and from time to time a sample is taken for determination of the hydroxyl number. When the amount of condensate calculated beforehand as corresponding to complete conversion has been reached, the xylene fraction is removed by distillation. The reaction mixture is stirred at 200° C. until an acid number of less than 5 mg KOH/g (determined in accordance with DIN 53402) is reached. The mixture is cooled to 145° C. and dissolved in 994 parts by weight of pentyl acetate.

The resulting polyester resin has a solids content of 86.3% by weight and a viscosity of 15.1 dPas (determined in accordance with DIN EN ISO 2884-1). The resulting hydroxyl number is 220 mg KOH/g (determined in accordance with DIN 53240).

### Comparative Example 1

### Preparation of a Polyacrylate Polyol

A reactor which has been flushed with nitrogen and has a condenser mounted is charged with 720.86 parts by weight of pentyl acetate, and this initial charge is heated to 140° C., with stirring. In parallel, two separate feeds were prepared. Feed 1 was composed of 283.74 parts by weight of styrene, 498.47 parts by weight of ethylhexyl methacrylate, 728.53 parts by weight of 4-hydroxybutyl acrylate, and 23.01 parts by weight of acrylic acid. Feed 2 was composed of 92.02 parts by weight of pentyl acetate and 153.37 parts by weight of TBPEH. When the temperature of 140° C. was reached, feed 2 was metered in slowly and at a uniform rate over a period of 285 minutes. 15 minutes after the commencement of feed 2, feed 1 was metered into the reactor slowly and at a uniform rate over a period of 240 minutes. After the end of the metering of feed 2, the reaction mixture was stirred at 140° C. for a further 120 minutes, for postpolymerization. The solids content of the resulting product was found to be 65.20%, the acid number 14.4 mg KOH/g, the OH number 185.1 mg KOH/g (in each case based on the solids), and a viscosity 20 dPa·s at 23° C.

### Comparative Example 2

### Preparation of a Polyacrylate Polyol

A reactor which has been flushed with nitrogen and has a condenser mounted is charged with 865.03 parts by weight of pentyl acetate, and this initial charge is heated to 140° C., with stirring. In parallel, two separate feeds were prepared. Feed 1 was composed of 303.68 parts by weight of styrene, 561.35 parts by weight of ethylhexyl methacrylate, 947.85 parts by weight of 4-hydroxybutyl acrylate, and 27.61 parts by weight of acrylic acid. Feed 2 was composed of 110.43 parts by weight of pentyl acetate and 184.05 parts by weight of TBPEH. When the temperature of 140° C. was reached, feed 2 was metered in slowly and at a uniform rate over a period of 285 minutes. 15 minutes after the commencement of feed 2, feed 1 was metered into the reactor slowly and at a uniform rate over a period of 240 minutes. After the end of the metering of feed 2, the reaction mixture was stirred at 140° C. for a further 120 minutes, for postpolymerization. The solids content of the resulting product was found to be 66.45%, the acid number 13.83 mg KOH/g, the OH number 200.2 mg KOH/g (in each case based on the solids), and a viscosity 18 dPa·s at 23° C.

### Comparative Example 3

### Preparation of a Polyacrylate Polyol

A 5 liter Juvo laboratory reaction vessel with heating jacket, equipped with thermometer, stirrer, water separator, and top-mounted condenser, is charged with 288.0 g of pentyl acetate and 455.0 g of Cardura E10. With stirring and blanketing with 3 m³/h nitrogen, the initial charge is heated to 150° C. and, using a metering pump, a mixture of 72.0 g of di-tert-butyl peroxide and 187.0 g of pentyl acetate is added dropwise at a uniform rate over the course of 4.5 h. 0.25 h after the commencement of the feed, again using a metering pump, a mixture of 61.0 g of methyl methacrylate, 38.0 g of styrene, 756.0 g of hydroxyethyl methacrylate, 145.0 g of acrylic acid, and 363.0 g of n-butyl methacrylate is metered in at a uniform rate over the course of 4 h. After the end of the feed the temperature is maintained for around 2 h. The mixture is then cooled to 120° C. and adjusted with butyl acetate to a solids of 61%. Subsequently the polymer solution is filtered through a 5 μm GAF bag. The resulting resin has an acid number of 12.97 mg KOH/g (DIN 53402), an OH number of 260.1 mg KOH/g (in each case based on solids), a solids content of 61%±1 (60 min. 130° C.), and a viscosity of 11.5 dPa·s as measured in accordance with DIN ISO 2884.

TABLE 1
Overview of the properties of the inventive resin as compared
with those of the comparative examples

| | | | | Mn | |
|---|---|---|---|---|---|
| | | OH | | [g/mol] | Mw/Mn |
| Resin | Type | number | SP | (GPC) | (GPC) |
| SP1 | Polyester, | 220 | 9.88 | 2632 | 2.0 |
| | reactant | | | | |
| Comparative example 1 | Acrylate | 185 | 10.11 | 3676 | 3.7 |
| Comparative example 2 | Acrylate | 200 | 10.38 | 3988 | 3.9 |
| Comparative example 3 | Acrylate | 260 | 10.56 | 2494 | 2.8 |

The results of the acrylate resins investigated show that the acrylate-based polyols with a high OH number exhibit significantly higher solubility parameters than the acrylate-based polyols with a low OH number.

### Clearcoat Compositions

The abovementioned resins were used in the following weighed amounts to prepare the first component of a 2-component clearcoat material:

| | 1 | 2 | 3 | 4 |
|---|---|---|---|---|
| SP1 | 92.26 | | | |
| Acrylate from comparative example 1 | | 98.44 | | |
| Acrylate from comparative example 2 | | | 95.30 | |
| Acrylate from comparative example 3 | | | | 84.64 |
| Butanol | 2.39 | 1.73 | 1.73 | 2.39 |
| GB Ester¹ | 7.38 | 5.36 | 5.36 | 7.38 |
| MPA² | 12.41 | 9.01 | 9.01 | 12.41 |
| Pentyl acetate | 14.90 | 10.82 | 10.82 | 14.90 |
| Butyl acetate | 0 | 16.32 | 16.32 | 14.90 |
| BDGA³ | 7.67 | 5.57 | 5.57 | 7.67 |
| Ethoxypropyl acetate | 3.76 | 2.73 | 2.73 | 3.76 |
| Xylene | 2.10 | 1.52 | 1.52 | 2.10 |
| Byk 331⁴ | 0.14 | 0.11 | 0.11 | 0.14 |
| Byk ES-80⁵ | 0.29 | 0.21 | 0.21 | 0.29 |
| Tinuvin 292⁶ | 1.45 | 1.05 | 1.05 | 1.45 |
| Tinuvin 384-2⁷ | 1.74 | 1.26 | 1.26 | 1.74 |

¹Glycolic acid n-butyl ester (G - B Ester), available under the tradename Polysolvan O from Celanese
²MPA = Methoxypropyl acetate
³BDGA = Butyldiglycol acetate
⁴Polyether-modified polydimethylsiloxane, Byk-Chemie GmbH, Wesel
⁵Additive, Byk-Chemie GmbH, Wesel
⁶Stabilizer based on sterically hindered amines, Ciba Specialty Chemicals, Basle, Switzerland
⁷UV absorber, Ciba Specialty Chemicals, Basle, Switzerland

To produce 2-component clearcoat coatings, the first components prepared as detailed above are homogenized with the weighed amounts, given below, of the second component (polyisocyanate curing agent Basonat HI 190 from BASF Aktiengesellschaft), and the homogenized mixtures are applied directly after homogenization. This was done using metal test panels which had each been coated with a customary and known, cathodically deposited, thermally cured electrocoat, a customary and known, thermally cured surfacer coat, and a film, subjected to preliminary drying at 80° C. for 10 minutes, of a commercially customary, conventional black basecoat material from BASF Coatings AG. The basecoat film and the clearcoat film were cured jointly at 140° C. for 22 minutes. The resulting basecoat had a coat thickness of 7.5 μm, the resulting clearcoat a thickness of 35 μm.

| | | | | |
|---|---|---|---|---|
| Basonat HI 190^{B} | 65.02 | 45.68 | 47.95 | 55.35 |

⁸Commercial binder, isocyanurate HDI, isocyanate content 19.3-20.3%, SP value 9.4 (90% strength solution in a 1:1 mixture of n-butyl acetate and Solvesso ® 100

The properties of the resulting clearcoat coatings are as follows:

| | 1 | 2 | 3 | 4 |
|---|---|---|---|---|
| Solids content of the mixture | 65.4 | 55.7 | 55.0 | 55.4 |
| [% by weight] | | | | |
| Microhardness [N/mm²]⁹ | 97 | 61 | 70 | 124 |
| Surface optical qualities | 2 | 0 | 0-1 | 0 |
| (appearance)¹⁰ | | | | |
| AMTEC residual gloss after | 87 | 92 | 90 | 79 |
| cleaning [%] | | | | |

⁹Determined in accordance with DIN EN ISO 14577 using the Fischerscope instrument from Fischer with a maximum force of 25.6 mN
¹⁰Determined by inspection of the cured films: 0 = uneven surface, poor surface optical qualities; 1 = extremely matt surface, poor surface optical qualities; 2 = smooth surface, very good surface optical qualities

The experimental results show that the low SP value results in good optical properties (appearance). In corresponding clearcoat compositions, resins with a higher SP value exhibit significantly poorer optical properties than the high-OH-number polyester-based resins of the invention.

Furthermore, however, the binders of the invention also display good microhardness and a satisfactory residual gloss.

As a further advantage of the resins of the invention it is possible to achieve substantially higher solids contents as compared with conventional compositions.

1.-28. (canceled)

29. A hydroxy-functional binder, comprising a hydroxyl number ≧180 mg KOH/g, determined in accordance with DIN 53240, and a solubility parameter SP ≦10.

30. The binder of claim 29, having an SP of 8.8-10.0.

31. The binder of claim 29, having an OH number, determined in accordance with DIN 53240, of ≧200 mg KOH/g.

32. The binder of claim 29, comprising a number-average molecular weight of ≦4000 g/mol, determined via GPC with a polystyrene standard in THF with 0.1% by weight of acetic acid.

33. The binder of claim 29, being at least one of a polyester polyol, a polyacrylate polyol, a polyurethane polyol, a polyether polyol, a polycarbonate polyol or a combination of two or more of the foregoing.

34. The binder of claim 29, being a polyester polyol, and at least one hydroxyl function of the polyester having been esterified with at least one noncyclic aliphatic monocarboxylic acid.

35. The binder as claimed in claim 34, wherein at least one hydroxyl function of the polyester has been esterified with at least one acid selected from the group of isomeric C₈-C₉ monocarboxylic acids.

36. The binder as claimed in claim 35, wherein at least one hydroxyl function of the polyester has been esterified with at least one of octanoic acid or isononanoic acid.

37. The binder of claim 29, having a polydispersity M_{w}/Mₙ<4.

38. The binder of claim 29, being a hyperbranched, dendritic compound.

39. The binder of claim 38, being a polyester which is partially esterified with a noncyclic aliphatic mono carboxylic acid, and which is prepared by partial esterification of a hydroxy-functional polyester which in turn is prepared via a process for the synthesis of a dendritic polymeric polyfunctional polyalcohol (polyester polyol) having reactive and optionally protected hydroxyl end groups,
the polymeric polyalcohol possessing n dendritic branches which spring from a monomeric or polymeric initiator molecule having n reactive groups (A), each branch comprising g branching generations, each generation comprising at least one polymeric or monomeric branching chain extender having three functional groups, of which at least two are reactive hydroxyl groups (B) and one is a carboxyl group (C) which is reactive with the reactive group (A) and/or the hydroxyl groups (B), and optionally comprising, at least one spacer generation which comprises at least one spacer chain extender having two functional groups, of which one is a protected hydroxyl group (B″) and one is a group (D) which is reactive with a hydroxyl group, n and g being integers and being at least 1,
(i) the two hydroxyl groups (B) of the monomeric or polymeric chain branching extender used being acetal-protected hydroxyl groups (B″), the acetal protection being obtained through a reaction between the two hydroxyl groups (B) and an acetal-forming carbonyl compound; and
(ii) a first branching generation being added to the initiator molecule by reaction between the reactive group (A) and the carboxyl group (C), in a molar ratio of the reactive groups (A) to the carboxyl groups (C) of at least 1, to give a polymeric polyalcohol having acetal-protected hydroxyl groups (B′) and n dendritic branches which comprise one generation, the acetal-protected hydroxyl groups (B′) being optionally deprotected, by means of acetal cleavage, to give a polymeric polyalcohol having reactive hydroxyl groups (B); and
(iii) further branching generations being added in g−1 repeated steps by reaction between reactive hydroxyl groups (B), which are obtained by deprotection by means of acetal cleavage, and carboxyl groups (C), in a molar ratio of hydroxyl groups (B) to carboxyl groups (C) of least 1, to give a polymeric polyalcohol having acetal-protected hydroxyl groups (B′) and n dendritic branches, which comprise two or more generations, the acetal-protected hydroxyl groups (B′) being optionally deprotected, by means of acetal cleavage, to give a polymeric polyalcohol having reactive hydroxyl groups (B), and
optionally (iv) step (ii) and/or each repetition of step (iii) individually is followed by
(a) a partial protection, such as protection as acetal, ketal and/or ester, for example, of available reactive hydroxyl groups (B), to give a polymeric polyalcohol having at least one reactive hydroxyl group (B) for use in step (iii) or in a repeated step (ii), and/or by
(b) the addition of the optional spacer chain extender, which after deprotection of the protected hydroxyl group (B″) gives a polymeric polyalcohol having reactive hydroxyl groups (B) for use in step (iii) or in a repeated step (iii) and n dendritic branches, which comprise one or more branching generations, and at least one spacer generation is at least one subgeneration.

40. The binder of claim 29, having an acid number of ≦10.

41. A clearcoat composition comprising at least one binder of claim 29.

42. The clearcoat composition of claim 41 further comprising at least one curing agent, the difference in the SP values of the curing agent and of the binder being not more than 1.0.

43. The clearcoat composition of claim 42, wherein the at least one curing agent comprises at least one member selected from the group consisting of an isocyanate curing agent, an amino resin curing agent and a trisalkoxycarbonylaminotriazine (TACT).

44. A process for preparing a hydroxy-functional binder of claim 29, which comprises
preparing a dendritic polyester polyol having reactive and optionally protected hydroxyl end groups, the polyester polyol possessing n dendritic branches which spring from a monomeric or polymeric initiator molecule having n reactive groups (A), each branch comprising g branching generations, each generation comprising at least one polymeric or monomeric branching chain extender having three functional groups, of which at least two are reactive hydroxyl groups (B) and one is a carboxyl group (C) which is reactive with the reactive group (A) and/or the hydroxyl groups (B), and optionally comprising, at least one spacer generation which comprises at least one spacer chain extender having two functional groups, of which one is a protected hydroxyl group (B″) and one is a group (D) which is reactive with a hydroxyl group, n and g being integers and being at least 1,
(i) the two hydroxyl groups (B) of the monomeric or polymeric chain branching extender used being acetal-protected hydroxyl groups (B′), the acetal protection being obtained through a reaction between the two hydroxyl groups (B) and an acetal-forming carbonyl compound; and
(ii) a first branching generation being added to the initiator molecule by reaction between the reactive group (A) and the carboxyl group (C), in a molar ratio of the reactive groups (A) to the carboxyl groups (C) of at least 1 to give a polyester polyol having acetal-protected hydroxyl groups (B′) and n dendritic branches which comprise one generation, the acetal-protected hydroxyl groups (B′) being optionally deprotected, by means of acetal cleavage, to give a polyester polyol having reactive hydroxyl groups (B); and
(iii) further branching generations being added in g−1 repeated steps by reaction between reactive hydroxyl groups (B), which are obtained by deprotection by means of acetal cleavage, and carboxyl groups (C), in a molar ratio of hydroxyl groups (B) to carboxyl groups (C) of least 1, to give a polyester polyol having acetal-protected hydroxyl groups (B′) and n dendritic branches, which comprise two or more generations, the acetal-protected hydroxyl groups (B′) being optionally deprotected, by means of acetal cleavage, to give a polyester polyol having reactive hydroxyl groups (B), and
optionally (iv) step (ii) and/or each repetition of step (iii) individually is followed by
(a) a partial protection, such as protection as acetal, ketal and/or ester, for example, of available reactive hydroxyl groups (B), to give a polyester polyol having at least one reactive hydroxyl group (B) for use in step (iii) or in a repeated step (ii), and/or by
(b) the addition of the optional spacer chain extender, which after deprotection of the protected hydroxyl group (B″) gives a polyester polyol having reactive hydroxyl groups (B) for use in step (iii) or in a repeated step (iii) and n dendritic branches, which comprise one or more branching generations, and at least one spacer generation is at least one subgeneration;
followed by a partial esterification of the polyester with a noncyclic aliphatic monocarboxylic acid, preferably an isomeric C₈-C₉ monocarboxylic acid.

45. A process for preparing the hydroxy-functional binder of claim 44 which further comprises partially esterifying a hyperbranched, dendritic, hydroxy-functional polyester with at least one noncyclic aliphatic monocarboxylic acid.

46. A substrate coated with a clearcoat composition of claim 41.

47. A method of making a coated substrate, comprising applying the clearcoat composition of claim 41 to a substrate.
